(19) United States
(12) Patent Application Publication
(10) Pub. No.: US 2015/0244900 A1
(43) Pub. Date: Aug. 27, 2015

(54) IMAGE PROCESSING DEVICE AND METHOD, IMAGE PROCESSING SYSTEM, AND NON-TRANSITORY COMPUTER-READABLE MEDIUM

(71) Applicant: FUJI XEROX CO., LTD, Tokyo (JP)

(72) Inventor: Tomohiro KICHIKAWA, Kanagawa (JP)

(73) Assignee: FUJI XEROX CO., LTD, Tokyo (JP)

(21) Appl. No.: 14/456,133

(22) Filed: Aug. 11, 2014

(30) Foreign Application Priority Data
Feb. 25, 2014 (JP) 2014-033793

(51) Int. Cl. H04N 1/38; H04N 1/21; H04N 1/40; H04N 1/00

(52) U.S. Cl. CPC H04N 1/38; H04N 1/00307; H04N 1/2108; H04N 1/00411; H04N 1/00816; H04N 1/00824; H04N 1/40068; H04N 2201/0081; H04N 2201/0084; H04N 2201/3274

(57) ABSTRACT

An image processing device includes a first image receiver that receives a first image used to specify an area within an image read by an image reading device, a second image receiver that receives a second image read by the image reading device, a decision unit that decides an area to extract from the second image on the basis of an area specified for the first image, and an extractor that extracts an image of the area decided by the decision unit from the second image.

### CROSS-REFERENCE TO RELATED APPLICATIONS

This application is based on and claims priority under 35 USC 119 from Japanese Patent Application No. 2014-033793 filed Feb. 25, 2014.

### BACKGROUND

### Technical Field

The present invention relates to an image processing device and method, an image processing system, and a non-transitory computer-readable medium.

### SUMMARY

According to an aspect of the invention, there is provided an image processing device that includes a first image receiver that receives a first image used to specify an area within an image read by an image reading device, a second image receiver that receives a second image read by the image reading device, a decision unit that decides an area to extract from the second image on the basis of an area specified for the first image, and an extractor that extracts an image of the area decided by the decision unit from the second image.

### BRIEF DESCRIPTION OF THE DRAWINGS

An exemplary embodiment of the present invention will be described in detail based on the following figures, wherein:

FIG. 1 is a schematic module configuration diagram for an exemplary configuration according to an exemplary embodiment;

FIG. 2 is a flowchart illustrating an exemplary process according to an exemplary embodiment;

FIG. 3 is a flowchart illustrating an exemplary process according to an exemplary embodiment;

FIG. 4 is a flowchart illustrating an exemplary process according to the exemplary embodiment;

FIG. 5 is a flowchart illustrating an exemplary process according to the exemplary embodiment;

FIG. 6 is an explanatory diagram illustrating an exemplary data structure of a scan reservation information table;

FIG. 7 is an explanatory diagram illustrating an exemplary data structure of a scan result registration information table;

FIG. 8 is an explanatory diagram illustrating an exemplary data structure of a document image saving table;

FIG. 9 is an explanatory diagram illustrating an exemplary data structure of an intermediate scanned image temporary saving table;

FIG. 10 is an explanatory diagram illustrating an exemplary data structure of a scanned image saving table;

FIGS. 11A and 11B are explanatory diagrams illustrating exemplary processing according to the exemplary embodiment;

FIGS. 12A and 12B are explanatory diagrams illustrating exemplary processing according to the exemplary embodiment;

FIG. 13 is an explanatory diagram illustrating exemplary processing according to the exemplary embodiment;

FIG. 14 is an explanatory diagram illustrating exemplary processing according to the exemplary embodiment;

FIG. 15 is an explanatory diagram illustrating exemplary processing according to the exemplary embodiment;

FIG. 16 is an explanatory diagram illustrating exemplary processing according to the exemplary embodiment;

FIG. 17 is a block diagram illustrating an exemplary hardware configuration of a computer that realizes an exemplary embodiment; and

FIG. 18 is a block diagram illustrating an exemplary hardware configuration of a computer that realizes an exemplary embodiment.

### DETAILED DESCRIPTION

Hereinafter, an exemplary embodiment related to realizing the present invention will be described by way of example on the basis of the drawings.

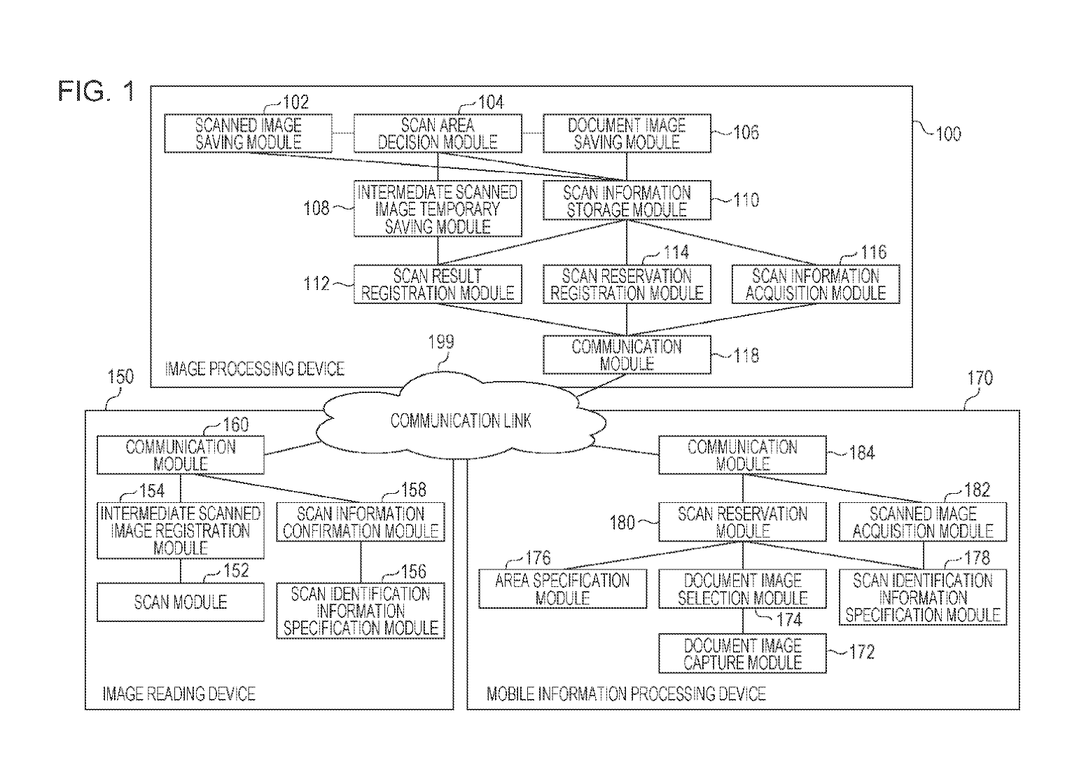

FIG. 1 illustrates a schematic module configuration for an exemplary configuration according to the exemplary embodiment.

Note that the term module refers to components such as software (computer programs) and hardware which are typically capable of being logically separated. Consequently, the term module in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage device is made to store information or that control is applied to cause a storage device to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predetermined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predetermined values”, the predetermined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “device” not only encompass configurations in which multiple computers, hardware, or devices are connected by a communication medium such as a network (including connections that support 1-to-1 communication), but also encompass configurations realized by a single computer, hardware, or device. The terms “device” and “system” are used interchangeably. Obviously, the term “system” does not include merely artificially arranged social constructs (social systems).

Also, every time a process is conducted by each module or every time multiple processes are conducted within a module, information to be processed is retrieved from a storage device, and the processing results are written back to the storage device after the processing. Consequently, description of the retrieval from a storage device before processing and the writing back to a storage device after processing may be reduced or omitted in some cases. Note that the storage device herein may include a hard disk, random access memory (RAM), an auxiliary or external storage medium, a storage device accessed via a communication link, and a register or the like inside a central processing unit (CPU).

As illustrated by the example in FIG. 1, an image processing system according to the exemplary embodiment is made up of an image processing device 100, an image reading device 150, and a mobile information processing device 170 communicably interconnected by a communication link 199. The image processing device 100 uses an area specified for a first image by the mobile information processing device 170 to extract an image of an area within a second image read in by the image reading device 150, and includes a scanned image saving module 102, a scan area decision module 104, a document image saving module 106, an intermediate scanned image temporary saving module 108, a scan information storage module 110, a scan result registration module 112, a scan reservation registration module 114, a scan information acquisition module 116, and a communication module 118. The image reading device 150 includes a scan module 152, an intermediate scanned image registration module 154, a scan identification information specification module 156, a scan information confirmation module 158, and a communication module 160. The mobile information processing device 170 includes a document image capture module 172, a document image selection module 174, an area specification module 176, a scan identification information specification module 178, a scan reservation module 180, a scanned image acquisition module 182, and a communication module 184. The communication link 199 may be wireless, wired, or a combination of the two, and may use the Internet or the like as a communication infrastructure, for example.

A user performs a scan with an image reading device 150 installed at a retail store (such as a convenience store), and is thereby able to save a scanned image on the Internet via the communication link 199. The user is then able to download and make use of the scanned image on a device such as a PC at home. In this case, in the original to be scanned, it is sometimes desirable to scan an image of just a partial area rather than the entire original.

Although an image of such an original may also be captured with a mobile information processing device 170 such as a mobile phone (including a smartphone) with a built-in camera function, such a camera function may be inferior to the image reading device 150 in terms of resolution, and may also be inferior to the image reading device 150 in terms of the quality of the image data (for example, there may be less distortion with the image reading device 150). On the other hand, with the mobile information processing device 170, it is possible to capture an image quickly and easily, and an operation such as drawing a rectangle on the image may also be performed.

In the exemplary embodiment, a user uses the mobile information processing device 170 to capture an original and perform an operation of enclosing a desired partial area within the original. Additionally, the entire image is read in by the image reading device 150. The image processing device 100 receives a first image with an enclosed partial area from the mobile information processing device 170 (hereinafter also called a document image), receives a second image corresponding to the document image from the image reading device 150 (hereinafter also called an intermediate scanned image), and cuts out an image of the desired partial area from the intermediate scanned image (hereinafter also called a scanned image).

Described using a more specific example, a user uploads a document image of a document captured with a camera function of the mobile information processing device 170 and area specification information for the document image to the image processing device 100 in advance. The uploaded information is saved in association with scan identification information (such as a user identifier or an identification number of the mobile information processing device 170 according to user authentication).

The user specifies the designated identification information on the image reading device 150, and scans all pages of the document in full. This scan result is temporarily registered in the image processing device 100 as an intermediate scanned image. In the image processing device 100, on the basis of the intermediate scanned image and the area specification information of the document image, a partial image specified area from the intermediate scanned image is registered as a scanned image.

First, respective modules of the mobile information processing device 170 will be described.

The communication module 184 is connected to the scan reservation module 180 and the scanned image acquisition module 182, and is also connected to the communication module 118 of the image processing device 100 and the communication module 160 of the image reading device 150 via the communication link 199. The communication module 184 communicates with the image processing device 100 or the image reading device 150. Specifically, the communication module 184 transmits a document image and information related to an area specified by the area specification module 176 (hereinafter also called area specification information) to the image processing device 100. Additionally, the communication module 184 may also transmit scan identification information discussed later.

The document image capture module 172 is connected to the document image selection module 174. The document image capture module 172 acquires a document image. Specifically, the document image capture module 172 captures a document image of an original by using a camera function of the mobile information processing device 170.

The document image selection module 174 is connected to the document image capture module 172 and the scan reservation module 180. The document image selection module 174 selects a document image to register in the image processing device 100 from among document images captured by the document image capture module 172.

The area specification module 176 is connected to the scan reservation module 180. The area specification module 176, on the basis of a user operation, specifies an area within the document image acquired by the scanned image acquisition module 182 that is to be extracted from within an intermediate scanned image. Specifically, the area desired as the scanned image (the desired partial area) is specified with a rectangle on the document image selected by the document image selection module 174. The user operation may be an operation performed by a finger or the like on a touch panel, or a cursor operation, for example. Specifically, the diagonal positions of a rectangle may be specified, for example. Consequently, writing on the original itself with a marker pen or the like may be omitted.

The scan identification information specification module 178 is connected to the scan reservation module 180 and the scanned image acquisition module 182. The scan identification information specification module 178 specifies identification information to be specified in the case of scanning the target original with the image reading device 150.

The scan reservation module 180 is connected to the document image selection module 174, the area specification module 176, the scan identification information specification module 178, and the communication module 184. The scan reservation module 180 associates together scan identification information specified by the scan identification information specification module 178, a document image selected by the document image selection module 174, and area specification information specified by the area specification module 176, and uploads the associated information to the image processing device 100 via the communication module 184. In other words, a document image and area specification information for that document image are registered in association with scan identification information.

The scanned image acquisition module 182 is connected to the scan identification information specification module 178 and the communication module 184. The scanned image acquisition module 182 acquires a scanned image from scanned information specified by the scan identification information specification module 178.

Next, respective modules of the image reading device 150 will be described.

The communication module 160 is connected to the intermediate scanned image registration module 154 and the scan information confirmation module 158, and is connected to the communication module 118 of the image processing device 100 and the communication module 184 of the mobile information processing device 170 via the communication link 199. The communication module 160 communicates with the image processing device 100 or the mobile information processing device 170. Specifically, the communication module 160 transmits an intermediate scanned image to the image processing device 100.

The scan identification information specification module 156 is connected to the scan information confirmation module 158. The scan identification information specification module 156 specifies the same scan identification information as the scan identification information specified by the scan reservation module 180.

The scan information confirmation module 158 is connected to the scan identification information specification module 156 and the communication module 160. The scan information confirmation module 158 confirms, from scanned information specified by the scan identification information specification module 156, whether or not a scan reservation has been registered by the mobile information processing device 170, and also whether or not a scan result has been registered by the image reading device 150.

The scan module 152 is connected to the intermediate scanned image registration module 154. The scan module 152 acquires an intermediate scanned image. In other words, the scan module 152 scans an original using a scan function of the image reading device 150, and creates an intermediate scanned image of the original.

The intermediate scanned image registration module 154 is connected to the scan module 152 and the communication module 160. The intermediate scanned image registration module 154 associates together scan identification information specified by the scan identification information specification module 156 and an intermediate scanned image created by the scan module 152, and uploads the associated information to the image processing device 100.

Next, respective modules of the image processing device 100 will be described.

The communication module 118 is connected to the scan result registration module 112, the scan reservation registration module 114, and the scan information acquisition module 116, and is connected to the communication module 160 of the image reading device 150 and the communication module 184 of the mobile information processing device 170 via the communication link 199. The communication module 118 communicates with the mobile information processing device 170 and the image reading device 150.

The scan reservation registration module 114 is connected to the scan information storage module 110 and the communication module 118. The scan reservation registration module 114 associates together and registers scan identification information, a document image, and area specification information uploaded from the mobile information processing device 170.

The scan information storage module 110 is connected to the scanned image saving module 102, the scan area decision module 104, the document image saving module 106, the scan result registration module 112, the scan reservation registration module 114, and the scan information acquisition module 116. The scan information storage module 110 stores scan reservation information (scan identification information, a document image, and area specification information) received by the scan reservation registration module 114, and scan result information (scan identification information, scan area information, and a scanned image) received by the scan result registration module 112. The scan information storage module 110 stores a document image, area specification information, scan area information, and a scanned image in association with scan identification information.

The document image saving module 106 is connected to the scan area decision module 104 and the scan information storage module 110. The document image saving module 106 saves a document image received by the scan reservation registration module 114.

The scan result registration module 112 is connected to the intermediate scanned image temporary saving module 108, the scan information storage module 110, and the communication module 118. The scan result registration module 112 extracts an image of an area decided by the scan area decision module 104 from an intermediate scanned image, and generates a scanned image.

Specifically, the scan result registration module 112 receives scan identification information and an intermediate scanned image uploaded from the image reading device 150. The scan result registration module 112 temporarily saves the intermediate scanned image in association with the scan identification information in the intermediate scanned image temporary saving module 108. The scan result registration module 112 creates a scanned image from a scan area decided by the scan area decision module 104 and the intermediate scanned image, and registers the scan area information and the scanned image in association with the same scan identification information.

The intermediate scanned image temporary saving module 108 is connected to the scan area decision module 104 and the scan result registration module 112. The intermediate scanned image temporary saving module 108 temporarily saves an intermediate scanned image received by the scan result registration module 112 in association with scan identification information. When scan area information is decided by the scan area decision module 104, the intermediate scanned image is deleted.

The scan area decision module 104 is connected to the scanned image saving module 102, the document image saving module 106, the intermediate scanned image temporary saving module 108, and the scan information storage module 110. The scan area decision module 104 receives a document image used to specify an image within an image acquired by the image reading device 150. For example, the scan area decision module 104 may be configured to receive an image acquired by the scanned image acquisition module 182 provided in the mobile information processing device 170.

Also, the scan area decision module 104 receives an intermediate scanned image acquired by the image reading device 150. Specifically, the scan area decision module 104 may be configured to receive an image acquired by the image reading device 150 that is readable at a higher resolution than a document image.

Subsequently, the scan area decision module 104 decides an area to extract from the intermediate scanned image on the basis of an area specified for the document image. Next, the scan area decision module 104 instructs the scan result registration module 112 to extract an image of the decided area from the intermediate scanned image.

For example, the scan area decision module 104 decides scan area information from a document image, area specification information, and an intermediate scanned image corresponding to the same scan identification information. The decided scan area information is registered in the scan information storage module 110 in association with the scan identification information.

In addition, the scan area decision module 104 may also be configured to judge whether or not an intermediate scanned image corresponding to a document image is being stored in the intermediate scanned image temporary saving module 108, and in the case of judging that an intermediate scanned image corresponding to a document image is being stored in the intermediate scanned image temporary saving module 108, take the intermediate scanned image corresponding to the document image from the intermediate scanned image temporary saving module 108, and extract an image of the decided area.

Also, the scan area decision module 104 may also be configured so that, in the case of judging that an intermediate scanned image corresponding to a document image is not being stored in the intermediate scanned image temporary saving module 108, the scan area decision module 104 reports to the user that an intermediate scanned image has not been acquired by the image reading device 150. In other words, a user's forgetting to scan may be avoided. Herein, the term user may refer to a user of the mobile information processing device 170, or a predetermined person. The user of the mobile information processing device 170 and the user of the image reading device 150 may also be different. For example, the image reading device 150 may be used by a person B instructed to scan an original by a user A of the mobile information processing device 170. For example, a table associating the mobile information processing device 170 and an email address of the user B may be prepared in advance, and if a document image accompanied by scan identification information is received from the mobile information processing device 170 and a predetermined period passes, the table may be used to transmit to the email address of the user B a message indicating to scan an original. The scan identification information is included inside this message.

Additionally, the scan area decision module 104 may also be configured to receive a document image and area-related information transmitted from the communication module 184 of the mobile information processing device 170, receive an intermediate scanned image transmitted from the communication module 160 of the image reading device 150, and on the basis of the area-related information, decide an area to extract from the intermediate scanned image.

The scanned image saving module 102 is connected to the scan area decision module 104 and the scan information storage module 110. The scanned image saving module 102 saves a scanned image created by the scan result registration module 112.

The scan information acquisition module 116 is connected to the scan information storage module 110 and the communication module 118. The scan information acquisition module 116 acquires, from the scan information storage module 110, scan information with respect to scan identification information received from the mobile information processing device 170 or the image reading device 150.

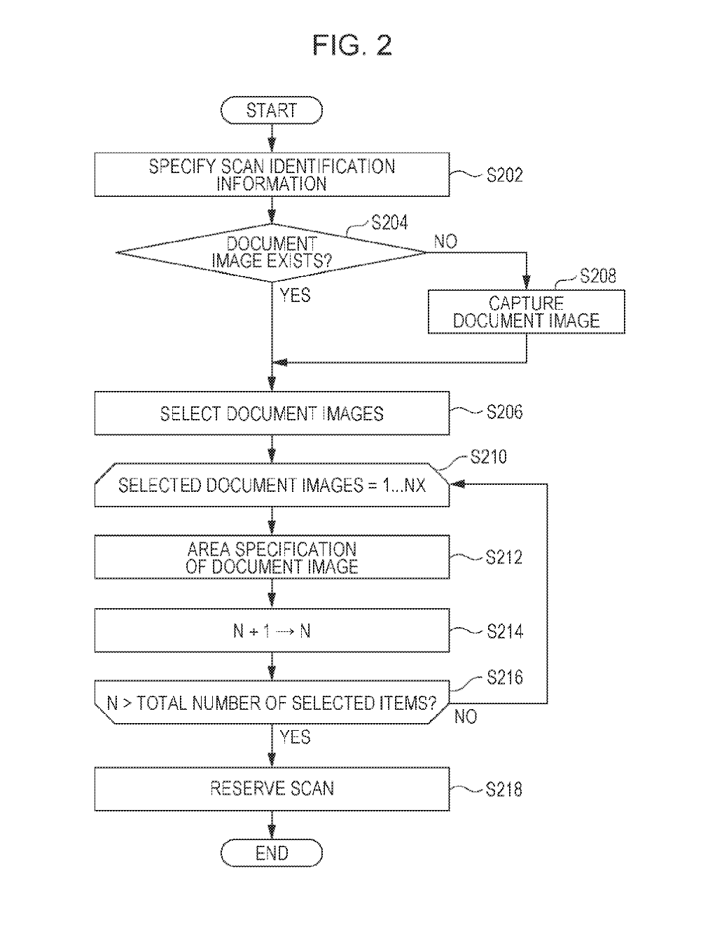

FIG. 2 is a flowchart illustrating an exemplary process (an exemplary scan reservation process) by the exemplary embodiment (specifically the mobile information processing device 170).

In step S202, scan identification information is specified. The scan identification information includes the following, for example.
A user identifier obtained by user authentication
A device identifier assigned to the mobile information processing device 170
A scan reservation number, automatically generated during a scan reservation, that does not overlap with other scan reservation numbers

The scan identification information may be input by user operations, automatically specified by the mobile information processing device 170, or created on the image processing device 100 side.

In step S204, it is judged whether or not a document image exists. The process proceeds to step S206 if a document image exists, and proceeds to step S208 if not. It is judged whether or not there exists a document image including an image that a user wants to scan. If a document image exists in the mobile information processing device 170, the process proceeds to step S206, and if a document image does not exist, the process proceeds to step S208.

In step S208, a document image is captured. The document image capture module 172 (camera function) of the mobile information processing device 170 is used to capture a document image including an image to be scanned.

In step S206, a document image is selected. According to a user operation, a document image including an image to be scanned is selected from a list of document image existing in the mobile information processing device 170. At this point, multiple document images may also be selected by a user operation.

In step S210, if there are multiple document images selected in step S206, the process from step S212 to step S216 is looped a number of times equal to the total number of selected document images (NX).

In step S212, an area of a document image is specified. The user specifies on the selected document image an area of an image to be scanned. The area specification method may be one of the following, for example.
The user specifies an area by directly inputting vertex information of a rectangular area.
The user marks (such as with a circle) an image to be scanned, and an area is specified by automatically detecting image area information from the mark information.
Images and image area information are automatically extracted from the selected document image, and the user specifies an area by selecting an image to be scanned from among multiple images.

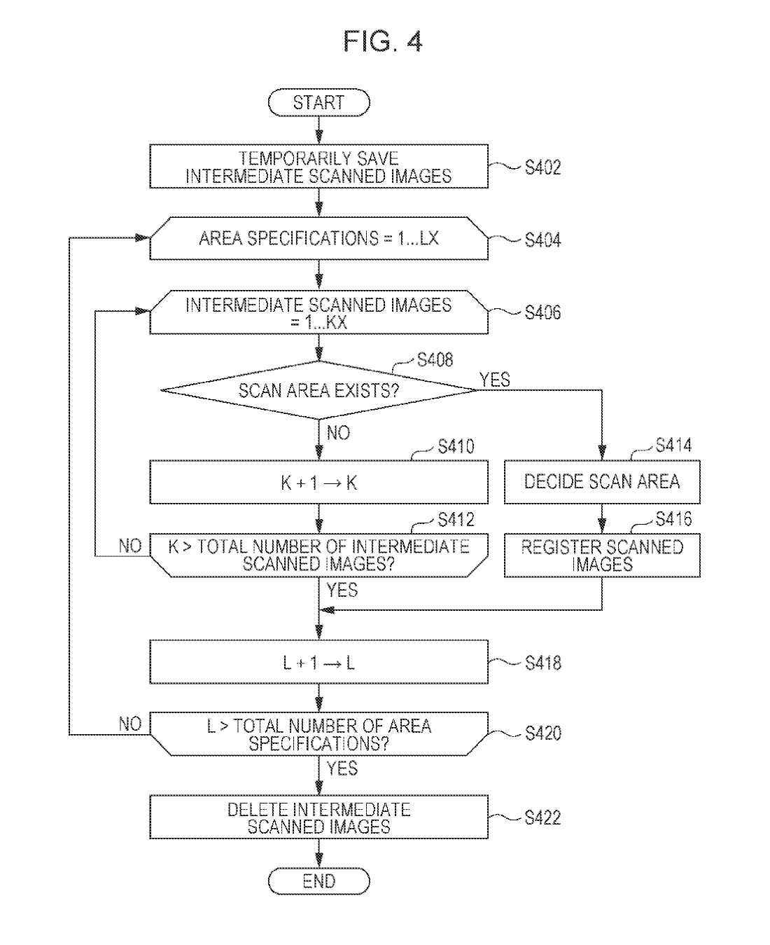

If there exist multiple images to be scanned in a single document image, multiple areas are specified for the single document image. Also, information like the following may be included in the area specification information in order to improve determination accuracy in the processing of step S408 illustrated by the example in FIG. 4 to be discussed later.
Device information obtained when capturing the document image (such as information about the orientation of the capture device)
Capture parameters obtained when capturing the document image (such as the capture time, capture environment, and distance to the imaged subject).

In step S214, the variable N+1 is substituted into the variable N (the variable N is incremented). In other words, preparations are made to conduct the next repetition of the process.

In step S216, it is judged whether or not the variable N is greater than the total number of selected document images (NX), and if so, the process proceeds to step S218, and otherwise returns to step S210. In other words, the loop process ends if a subsequent selected document image does not exist.

In step S218, a scan is reserved. In other words, the scan identification information, document image, and area specification information obtained by the processing from step S202 to step S216 are uploaded to the image processing device 100, and the image processing device 100 associates together and registers the scan identification information, document image, and area specification information as scan information for a scan reservation.

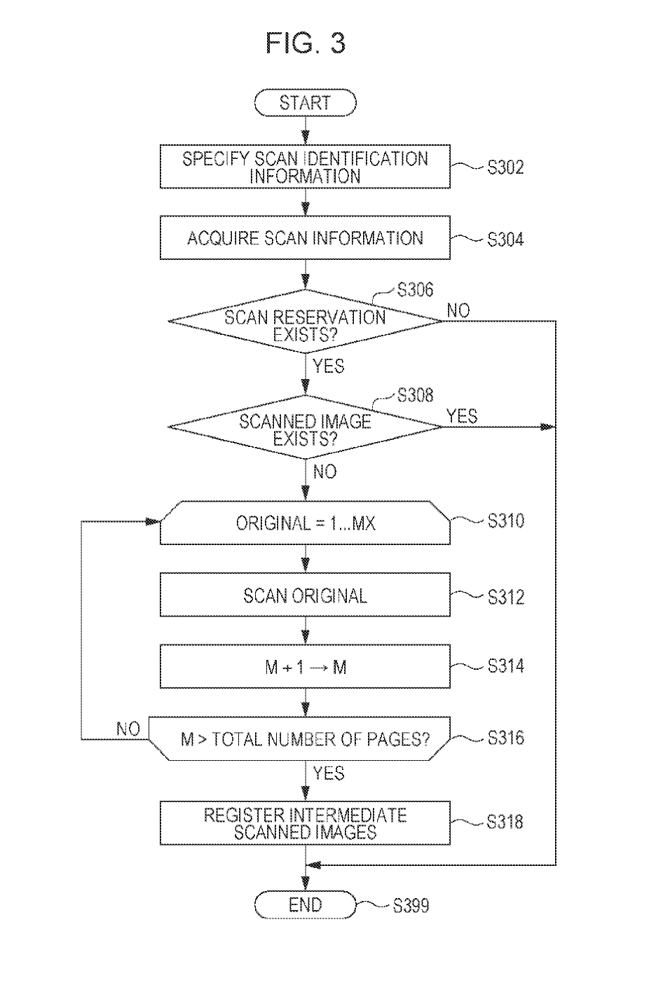

FIG. 3 is a flowchart illustrating an exemplary process (an exemplary intermediate scanned image registration process) by the exemplary embodiment (specifically the image reading device 150).

In step S302, scan identification information is specified, similarly to step S202.

In step S304, scan information associated with the scan identification information specified in step S302 is acquired. If scan information associated with the scan identification information does not exist, there is obtained scan information indicating that a scan reservation with respect to the scan identification information has not been conducted.

In step S306, it is judged from the scan information acquired in step S304 whether or not a scan reservation has been registered. If a scan reservation is registered, the process proceeds to step S308, whereas if a scan reservation has not been registered, an error screen is displayed or the like and the process is aborted (step S399).

In step S308, it is judged whether or not a scanned image exists. The process ends (step S399) if a scanned image exists, and proceeds to step S310 is not.

In step S310, if the user possesses multiple originals, the process from step S312 to step S316 is looped a number of times equal to the total number of pages (MX).

In step S312, an original is scanned. According to a user operation, the scan module 152 (scan function) of the image reading device 150 is used to scan an original. A full image of the scanned original is saved as an intermediate scanned image. Note an original that does not include an image to be scanned, or in other words, a original that does not need to be scanned, may also be scanned together with an original to be scanned.

In step S314, the variable M+1 is substituted into the variable M (the variable M is incremented). In other words, preparations are made to conduct the next repetition of the process.

In step S316, it is judged whether or not the variable M is greater than the total number of pages (MX), and if so, the process proceeds to step S318, and otherwise returns to step S310. In other words, the loop process ends if a subsequent original does not exist.

In step S318, an intermediate scanned image is registered. In other words, the scan identification information and intermediate scanned image obtained by the processing from step S302 to step S316 are uploaded to the image processing device 100, and the image processing device 100 associates together and registers the scan identification information and intermediate scanned image as scan information for an intermediate scanned image registration. Subsequently, the process proceeds to step S402 in order to register a scan result.

FIG. 4 is a flowchart illustrating an exemplary process (an exemplary scan result registration process) by the exemplary embodiment (specifically the image processing device 100).

In step S402, an intermediate scanned image is temporarily saved. In other words, scan identification information and an intermediate scanned image registered by step S318 are associated together and temporarily saved.

In step S404, area specification information associated with the scan identification information of step S402 is acquired from the scan information storage module 110. If there are multiple area specifications, the process from step S406 to step S420 is looped a number of times equal to the total number of area specifications (LX).

In step S406, an intermediate scanned image associated with the scan identification information of step S402 is acquired from the intermediate scanned image temporary saving module 108. If there are multiple intermediate scanned images, the process from step S408 to step S412 is looped a number of times equal to the total number of intermediate scanned images (KX).

In step S408, it is judged whether or not a scan area exists. The process proceeds to step S414 if a scan area exists, and proceeds to step S410 if not. In other words, from area specification information and a document image corresponding to the area specification information, it is judged by image processing of an intermediate scanned image whether or not a scan area is included in the intermediate scanned image. If a scan area exists, the process proceeds to step S414, whereas if a scan area does not exist, the process proceeds to step S410.

The basis of judgment for whether or not a scan area is included may be a basis like the following.
A similarity of the layout pattern of the area specification with respect to the entire document image
A similarity of image feature information (such as color information or feature extraction) from the area specification portion of the document image

Additionally, since the document image is an image obtained by capturing an original (a paper sheet) using a camera function of the mobile information processing device 170, a determination is made after correcting for the following factors as appropriate.
Horizontal and vertical tilt of overall original with respect to capture device
Flexing, folding, tearing, or dirtiness of original itself
If there exist characters or underlining added after capturing the document image but before registering the intermediate scanned image, or if additional information for improving the determination accuracy is included in the area specification information in step S212, such additional information is accounted for when making a determination. For example, the additional information is removed from the intermediate scanned image, or the additional information is added to the document image.

In step S410, the variable K+1 is substituted into the variable K (the variable K is incremented). In other words, preparations are made to conduct the next repetition of the process.

In step S412, it is judged whether or not the variable K is greater than the total number of intermediate scanned images (KX), and if so, the process proceeds to step S418, and otherwise returns to step S406. In other words, the loop process ends if a subsequent document image does not exist.

In step S414, a scan area is decided. In other words, a scan area is decided from the scan area determination information determined in step S408, and an intermediate scanned image.

In step S416, a scanned image is registered. In other words, a scanned image is created from the scan area decided in step S414 and an intermediate scanned image, and the scanned image is saved in association with the scan identification information of step S402. After saving the scanned image, the loop process of step S406 to step S412 is aborted, and the process proceeds to the loop process of step S404 (step S418).

In step S418, the variable L+1 is substituted into the variable L (the variable L is incremented). In other words, preparations are made to conduct the next repetition of the process.

In step S420, it is judged whether or not the variable L is greater than the total number of selected area specifications (LX), and if so, the process proceeds to step S422, and otherwise returns to step S404. In other words, the loop process ends if a subsequent area specification does not exist.

In step S422, an intermediate scanned image is deleted.

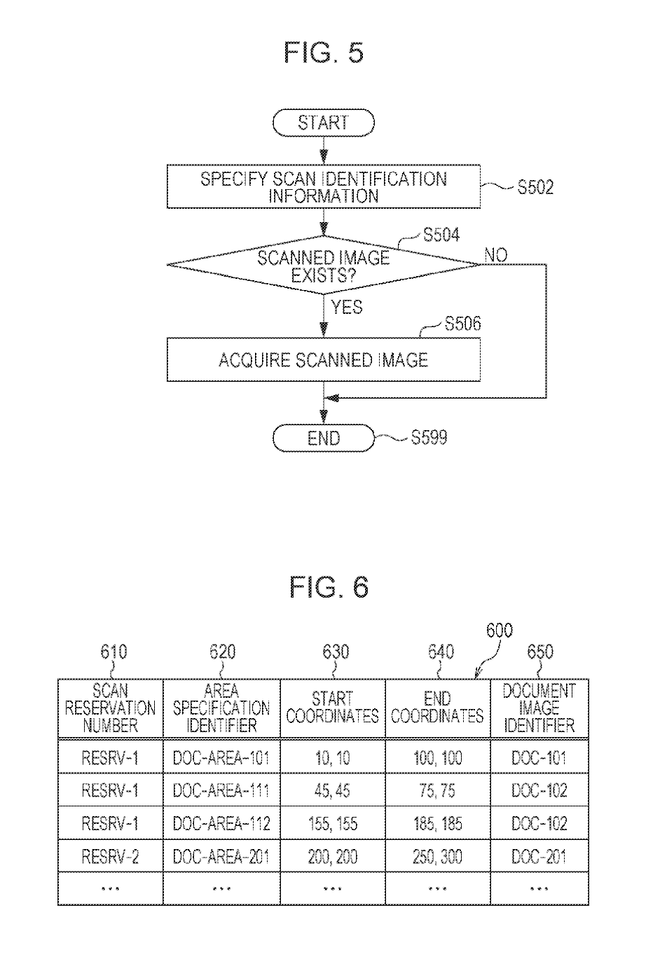

FIG. 5 is a flowchart illustrating an exemplary process (an exemplary scan image process) by the exemplary embodiment (specifically the image processing device 100).

In step S502, scan identification information is specified. In other words, scan identification information is specified, similarly to step S202.

In step S504, scan information associated with the scan identification information is acquired, and it is judged whether or not a scanned image exists. If a scanned image exists, the process proceeds to step S506, whereas if a scanned image does not exist, an error screen or the like is displayed and the process is ended (step S599).

In step S506, a scanned image associated with the scan identification information specified in step S502 is acquired.

Hereinafter, a scan reservation information table 600, a scan result registration information table 700, a document image saving table 800, an intermediate scanned image temporary saving table 900, and a scanned image saving table 1000 used in the exemplary embodiment will be described. These illustrate examples of data structures in the case of using the scan reservation number as the scan identification information.

The scan information storage module 110 stores a scan reservation information table 600, for example. FIG. 6 is an explanatory diagram illustrating an exemplary data structure of the scan reservation information table 600. The scan reservation information table 600 includes a scan reservation number field 610, an area specification identifier field 620, a start coordinates field 630, an end coordinates field 640, and a document image identifier field 650. The scan reservation number field 610 stores a scan reservation number as scan identification information. The area specification identifier field 620 stores an area specification identifier, which is part of the area specification information corresponding to that scan identification information. The start coordinates field 630 stores start coordinates (for example, the upper-left coordinates of a rectangle), which are part of the area specification information corresponding to that scan identification information. The end coordinates field 640 stores end coordinates (for example, the lower-right coordinates of a rectangle), which are part of the area specification information corresponding to that scan identification information. The document image identifier field 650 stores a document image identifier indicating a document image corresponding to that scan identification information.

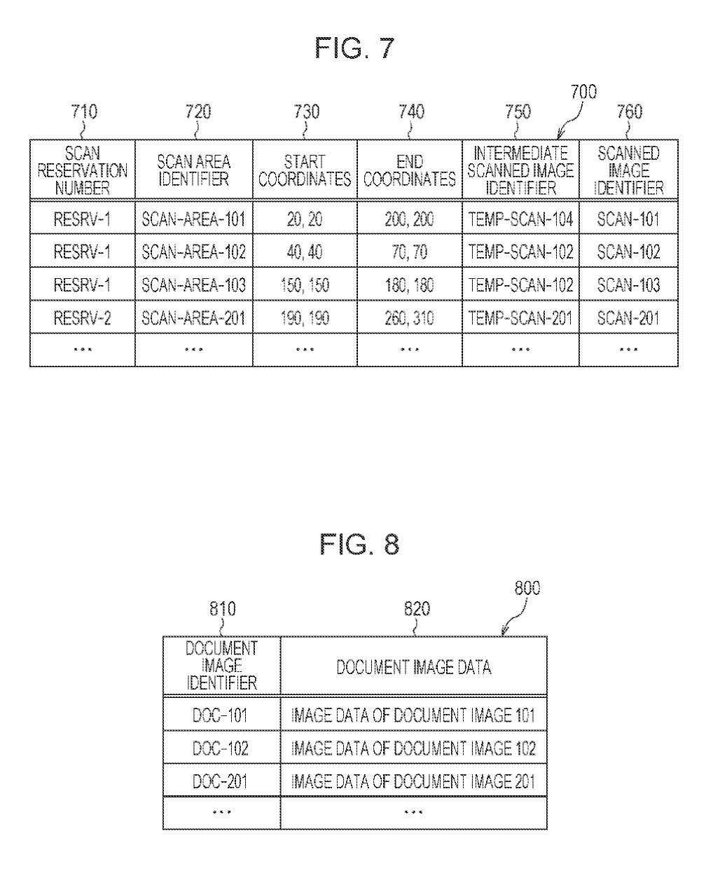

The scan result registration module 112 stores a scan result registration information table 700, for example. FIG. 7 is an explanatory diagram illustrating an exemplary data structure of the scan result registration information table 700.

The scan result registration information table 700 includes a scan reservation number field 710, a scan area identifier field 720, a start coordinates field 730, an end coordinates field 740, an intermediate scanned image identifier field 750, and a scanned image identifier field 760. The scan reservation number field 710 stores a scan reservation number as scan identification information. The scan area identifier field 720 stores a scan area identifier corresponding to that scan identification information. The scan area identifier specifies an area in an intermediate scanned image, and will be discussed later using FIGS. 14, 15, and 16. The start coordinates field 730 stores start coordinates (for example, the upper-left coordinates of a rectangle) corresponding to that scan area identifier. The end coordinates field 740 stores end coordinates (for example, the lower-right coordinates of a rectangle) corresponding to that scan area identifier. The intermediate scanned image identifier field 750 stores an intermediate scanned image identifier that indicates an intermediate scanned image corresponding to that scan identification information. The scanned image identifier field 760 stores a scanned image identifier that indicates a scanned image (an image resulting from an extraction process) corresponding to that scan identification information.

The document image saving module 106 stores a document image saving table 800, for example. FIG. 8 is an explanatory diagram illustrating an exemplary data structure of the document image saving table 800. The document image saving table 800 includes a document image identifier field 810 and a document image data field 820. The document image identifier field 810 stores a document image identifier. The document image data field 820 stores document image data indicated by that document image identifier.

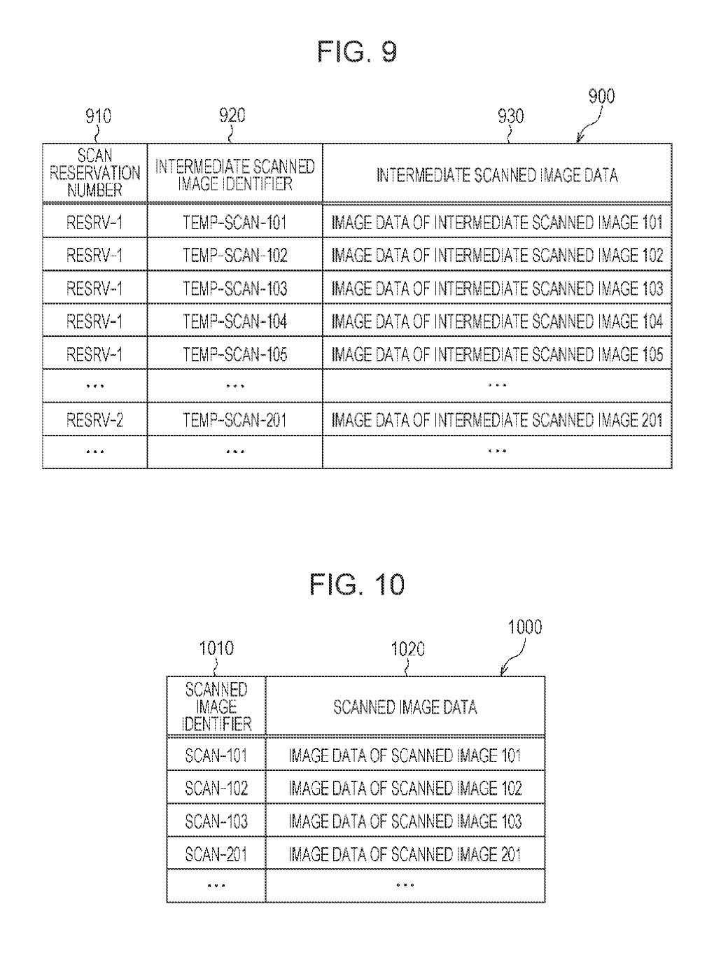

The intermediate scanned image temporary saving module 108 stores an intermediate scanned image temporary saving table 900, for example. FIG. 9 is an explanatory diagram illustrating an exemplary data structure of the intermediate scanned image temporary saving table 900. The intermediate scanned image temporary saving table 900 includes a scan reservation number field 910, an intermediate scanned image identifier field 920, and an intermediate scanned image data field 930. The scan reservation number field 910 stores a scan reservation number as scan identification information. The intermediate scanned image identifier field 920 stores an intermediate scanned image identifier corresponding to that scan identification information. The intermediate scanned image data field 930 stores intermediate scanned image data indicated by that intermediate scanned image identifier.

The scanned image saving module 102 stores a scanned image saving table 1000, for example. FIG. 10 is an explanatory diagram illustrating an exemplary data structure of the scanned image saving table 1000. The scanned image saving table 1000 includes a scanned image identifier field 1010 and a scanned image data field 1020. The scanned image identifier field 1010 stores a scanned image identifier. The scanned image data field 1020 stores scanned image data indicated by that scanned image identifier.

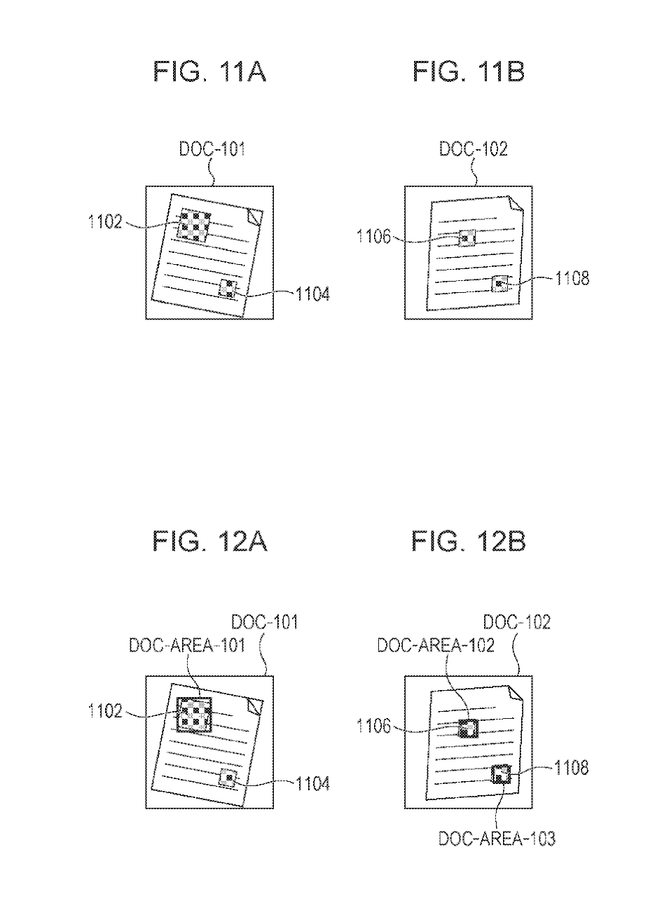

FIGS. 11A and 11B are explanatory diagrams illustrating an exemplary process by the exemplary embodiment (specifically the mobile information processing device 170). Particularly, FIGS. 11A and 11B are examples illustrating the processing in step S206.

Document images captured using the camera function of the mobile information processing device 170 are selected. For example, the selected document images may be DOC-101 illustrated by the example of FIG. 11A, and DOC-102 illustrated by the example of FIG. 11B. DOC-101 and DOC-102 are document images captured by a document image capture module 172 of a mobile information processing device 170 such as a mobile terminal or digital camera. In these document images, the originals have been captured at an angle. In other words, because the document images are captured by a user with a camera function of a mobile information processing device 170, the images of the originals (and obviously the images of the areas the user wants to scan that are included in those originals) may be tilted or skewed with respect to the document images in some cases. Also, in some cases, the document images may include images that the user does not want to scan. Herein, the area 1102, the area 1106, and the area 1108 are images of the areas that the user originally wanted to scan. The area 1104 is an image of an area that the user does not want to scan.

FIGS. 12A and 12B are explanatory diagrams illustrating an exemplary process by the exemplary embodiment (specifically the mobile information processing device 170). Particularly, FIGS. 12A and 12B are examples illustrating the processing in step S212. The user specifies an area of an image the user wants to scan on the document images (DOC-101, DOC-102). For example, on the DOC-101, a DOC-AREA-101 enclosing the area 1102 is specified, while on the DOC-102, a DOC-AREA-102 enclosing the area 1106 and a DOC-AREA-103 enclosing the area 1108 are specified. Since start coordinates and end coordinates are specified, depending on the tilt of the captured document, the captured document may not align with the frames around the images to be scanned. Also, since the user specifies areas by manual operations or the like, in some cases a discrepancy may occur between an image to be scanned and an area specification. Note that since the area 1104 is an area that the user does not want to scan, an area specification obviously is not conducted.

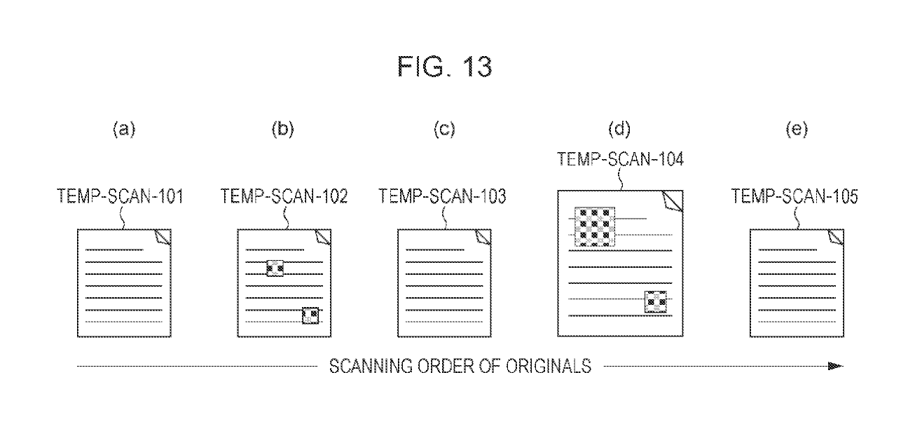

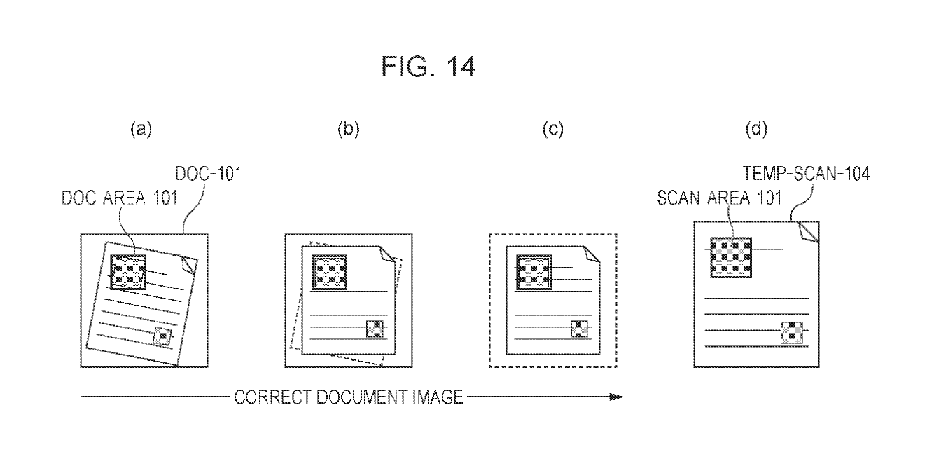

FIG. 13 is an explanatory diagram illustrating an exemplary process by the exemplary embodiment (specifically the image reading device 150). Particularly, FIG. 13 is an example illustrating the processing in step S312.

According to a user operation, the image reading device 150 scans an original that includes an image of an area that the user wants to scan. This scan result is temporarily saved as an intermediate scanned image. In the example of FIG. 13, TEMP-SCAN-101 indicated by the example (a), TEMP-SCAN-102 indicated by the example (b), TEMP-SCAN-103 indicated by the example (c), TEMP-SCAN-104 indicated by the example (d), and TEMP-SCAN-105 indicated by the example (e) are intermediate scanned images. Suppose that scanning is conducted in this order. Also, since these intermediate scanned images are scanned by the image reading device 150, there is less tilt, skew, and the like compared to an image captured using the camera function of the mobile information processing device 170.

These intermediate scanned images may also include intermediate scanned image of originals that do not include an area to be scanned (TEMP-SCAN-101, TEMP-SCAN-103, TEMP-SCAN-105). Additionally, the user may also not follow the original scan order.

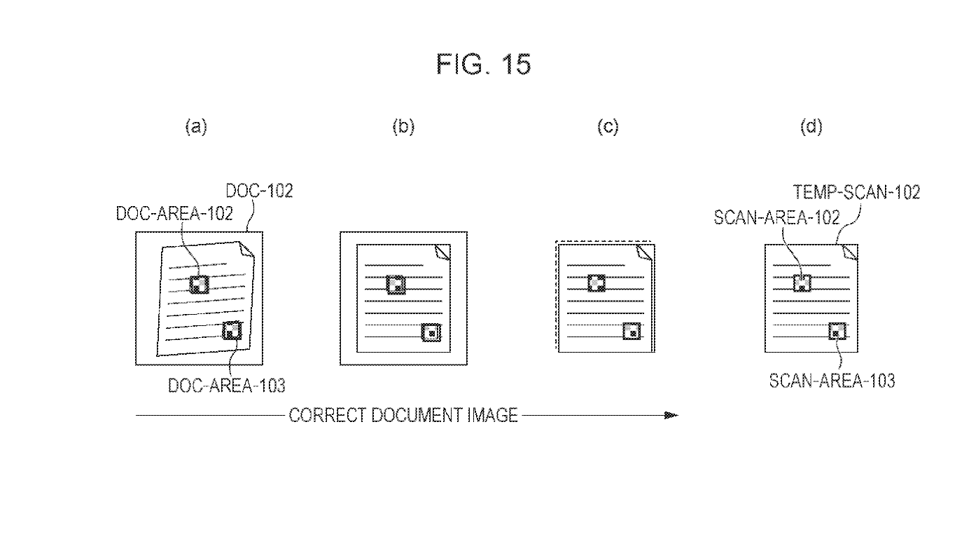

FIGS. 14 and 15 are explanatory diagrams illustrating an exemplary process by the exemplary embodiment (specifically the image processing device 100). Particularly, FIGS. 14 and 15 are examples illustrating the processing in step S408.

At this point, a scan area is decided from an area specification on a document image (such as DOC-AREA-101 illustrated by the example of FIG. 12A), a document image (such as DOC-101 illustrated by the example of FIG. 11A), and an intermediate scanned image (such as TEMP-SCAN-102 illustrated by the example of FIG. 13). When judging whether or not an image to be scanned is included, factors such as the tilt and skew of the document image are corrected as appropriate. This correction may use established technology. When comparing two sets of image data (a document image and an intermediate scanned image), a scan area is decided by pattern matching technology or the like after correcting for the size difference between the images.

The example (a) in FIG. 14 illustrates a document image DOC-101 and a DOC-AREA-101 enclosing the area 1102. The example (b) in FIG. 14 illustrates the result of correcting factors such as the tilt and skew of the document image DOC-101. The example (c) in FIG. 14 illustrates the document image to be compared to the intermediate scanned image group illustrated in the examples (a) to (e) of FIG. 13. Obviously, the image in example (c) of FIG. 14 may also be enlarged or reduced to match the size of the intermediate scanned images for comparison. Subsequently, as a result of the comparison, TEMP-SCAN-104 illustrated in the example (d) of FIG. 14 is extracted as an intermediate scanned image corresponding to the document image DOC-101, and in addition, SCAN-AREA-101 is designated as an area corresponding to DOC-AREA-101.

The example (a) in FIG. 15 illustrates a document image DOC-102, a DOC-AREA-102 enclosing the area 1106, and a DOC-AREA-103 enclosing the area 1108. The example (b) in FIG. 15 illustrates the result of correcting factors such as the tilt and skew of the document image DOC-102. The example (c) in FIG. 15 illustrates the document image to be compared to the intermediate scanned image group illustrated in the examples (a) to (e) of FIG. 13. Obviously, the image in example (c) of FIG. 15 may also be enlarged or reduced to match the size of the intermediate scanned images for comparison. Subsequently, as a result of the comparison, TEMP-SCAN-102 illustrated in the example (d) of FIG. 15 is extracted as an intermediate scanned image corresponding to the document image DOC-102, and in addition, SCAN-AREA-102 is designated as an area corresponding to DOC-AREA-102, and SCAN-AREA-103 is designated as an area corresponding to DOC-AREA-103.

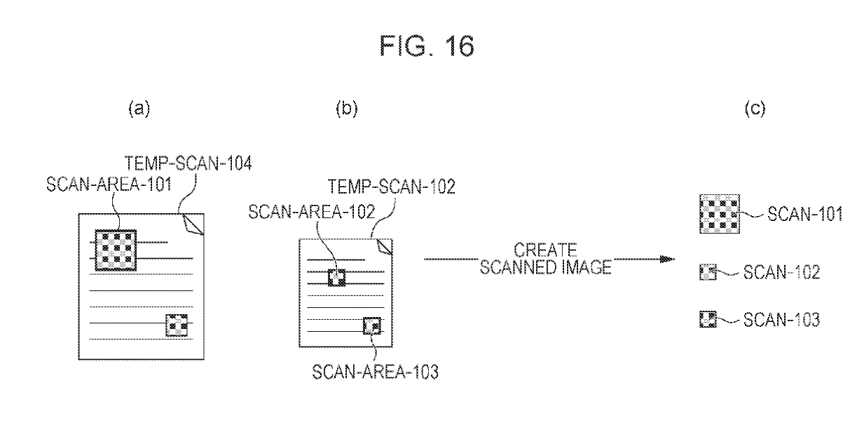

FIG. 16 is an explanatory diagram illustrating an exemplary process by the exemplary embodiment (specifically the image processing device 100). Particularly, FIG. 16 is an example illustrating the processing in step S416.

At this point, a scanned image is created from a scan area and an intermediate scanned image. In other words, as illustrated by the example (a) in FIG. 16, an image of the area enclosed by the scan area SCAN-AREA-101 is extracted from the intermediate scanned image TEMP-SCAN-104, and registered as the scanned image SCAN-101 illustrated by the example (c) in FIG. 16. In addition, as illustrated by the example (b) in FIG. 16, an image of the area enclosed by the scan area SCAN-AREA-102 is extracted from the intermediate scanned image TEMP-SCAN-102 and registered as the scanned image SCAN-102 illustrated by the example (c) in FIG. 16, and an image of the area enclosed by the scan area SCAN-AREA-103 is extracted from the intermediate scanned image TEMP-SCAN-102 and registered as the scanned image SCAN-103 illustrated by the example (c) in FIG. 16.

An image of an area extracted by the image processing device 100 may also be transmitted to the mobile information processing device 170 that specified that area.

As an example, it may be configured so that contact information, such as an IP address of the mobile information processing device 170 or an email address of the user, is included in the scan reservation transmitted from the scan reservation module 180 in step S218 of the flowchart illustrated by the example in FIG. 2. Alternatively, destination information such as an email address or file server address corresponding to the identification information of the user may be registered in the image processing device 100 in advance. Subsequently, after the extraction of an image of an area is completed, the scan result registration module 112 transmits the extracted image of the area to the above contact information or destination information, either after or at the same time as the registration of the extracted image.

When reporting or transmitting an extracted image of an area, it may be configured so that the resulting image itself is transmitted, or configured so that referral information for the extracted image of an area (for example, a URL for downloading) is reported, and the referral information is used to acquire the resulting image according to an operation by the user of the mobile information processing device 170. Also, when sending the referral information, a thumbnail of a scanned image (that is, an image indicating the shape and overall appearance of the specified area) may be generated, and the thumbnail may be transmitted together with the referral information. Subsequently, on the mobile information processing device 170, the resulting image and the like is displayed on a display device such as a liquid crystal display.

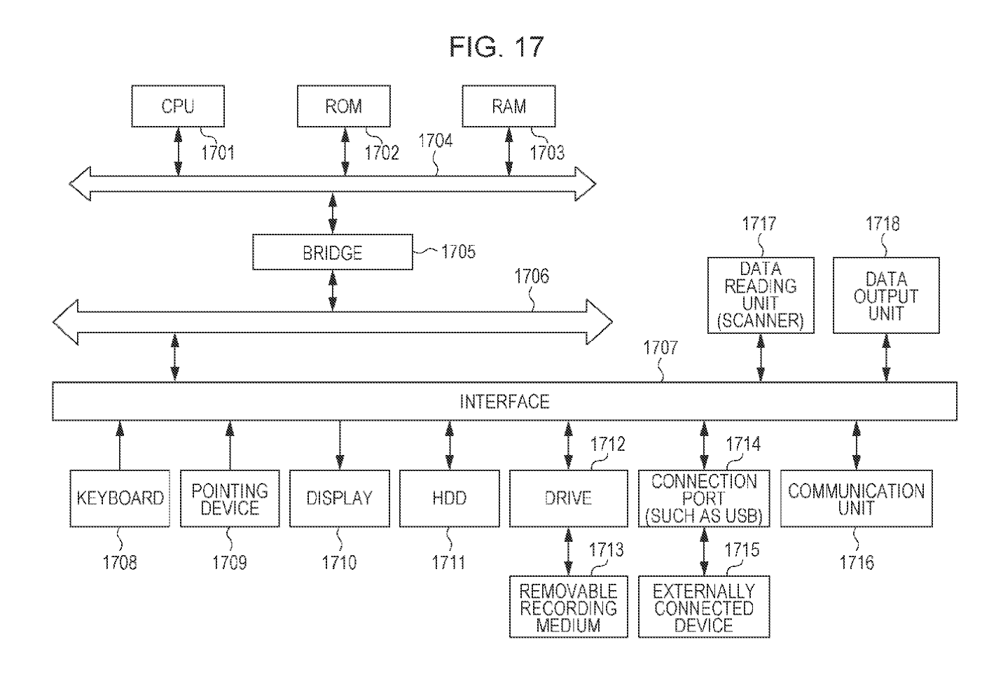

An exemplary hardware configuration of an image processing device (image processing device 100, image reading device 150) according to the present exemplary embodiment will now be described with reference to FIG. 17. The configuration illustrated in FIG. 17 may be realized by a personal computer (PC), for example, and illustrates an exemplary hardware configuration equipped with a data reading unit 1717 such as a scanner, and a data output unit 1718 such as a printer.

The central processing unit (CPU) 1701 is a controller that executes processing according to a computer program that states execution sequences for the various modules described in the foregoing exemplary embodiment, or in other words, for respective modules such as the scanned image saving module 102, the scan area decision module 104, the document image saving module 106, the scan reservation registration module 114, the scan information acquisition module 116, the scan module 152, the intermediate scanned image registration module 154, the scan identification information specification module 156, the scan information confirmation module 158, and the communication module 160.

The read-only memory (ROM) 1702 stores information such as programs and computational parameters used by the CPU 1701. The random access memory (RAM) 1703 stores information such as programs used during execution by the CPU 1701, and parameters that change as appropriate during such execution. These memory units are connected to each other by a host bus 1704 realized by a CPU bus, for example.

The host bus 1704 is connected to an external bus 1706 such as a Peripheral Component Interconnect/Interface (PCI) bus via the bridge 1705.

The keyboard 1708 and the mouse or other pointing device 1709 are input devices operated by a user. The display 1710 may be a liquid crystal display (LCD) or cathode ray tube (CRT) device, and displays various information as text and image information.

The hard disk drive (HDD) 1711 houses and drives a hard disk, causing programs executed by the CPU 1701 and information to be recorded thereto or retrieved therefrom. The hard disk stores information such as the scan reservation information table 600, the scan result registration information table 700, the document image saving table 800, the intermediate scanned image temporary saving table 900, and the scanned image saving table 1000. Additionally, various other computer programs such as various data processing programs are stored therein.

The drive 1712 reads out data or programs recorded onto a removable recording medium 1713 such as an inserted magnetic disk, optical disc, magneto-optical disc, or semiconductor memory, and supplies the data or programs to the RAM 1703 connected via the interface 1707, the external bus 1706, the bridge 1705, and the host bus 1704. The removable recording medium 1713 is usable as a data recording area similar to a hard disk.

The connection port 1714 is a port that connects to an externally connected device 1715, and has a USB, IEEE 1394, or similar receptacle. The connection port 1714 is connected to the CPU 1701 via the interface 1707 as well as the external bus 1706, the bridge 1705, and the host bus 1704. The communication unit 1716 is connected to a communication line and executes data communication processing with external equipment. The data reading unit 1717 may be a scanner, for example, and executes document scanning processing. The data output unit 1718 may be a printer, for example, and executes document data output processing.

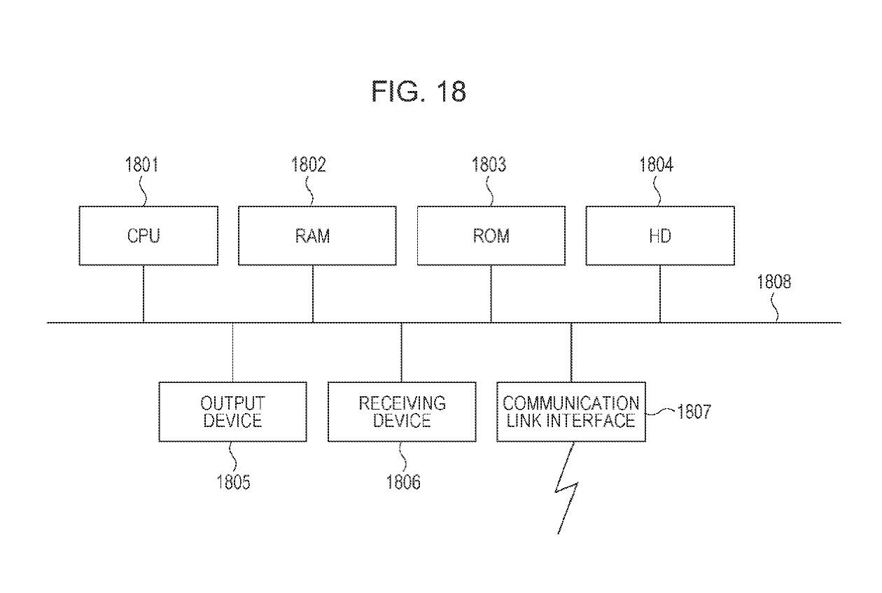

Note that a hardware configuration of a computer executing a program that acts as the present exemplary embodiment (mobile information processing device 170) is a general computer as illustrated by the example of FIG. 18, and specifically is a device such as a mobile phone, which includes a smartphone equipped with a camera, or a notebook computer. In other words, as a specific example, a CPU 1801 is used as a processing unit (computational unit), while RAM 1802, ROM 1803, and an HD 1804 are used as storage devices. For the HD 1804, a hard disk may be used, for example. The computer is made up of the CPU 1801 that executes programs such as the document image capture module 172, the document image selection module 174, the area specification module 176, the scan identification information specification module 178, the scan reservation module 180, the scanned image acquisition module 182, and the communication module 184, the RAM 1802 that stores such programs and data, the ROM 1803 that stores programs and the like for activating the computer, the HD 1804 which is an auxiliary storage device (and may also be flash memory or the like), a receiving device 1806 that receives an image captured by a camera, an image output device 1805 such as a CRT or liquid crystal display, a communication link interface 1807 such as a network interface card for connecting to a communication network, and a bus 1808 for joining and exchanging data with the above components. Multiple such computers may also be connected to each other by a network.

Of the foregoing exemplary embodiments, for those made up of a computer program, software in the form of a computer program is made to be read into a system with the above hardware configuration, and the foregoing exemplary embodiments are realized by the cooperative action of the software and hardware resources.

Note that the hardware configuration illustrated in FIGS. 17 and 18 illustrate a single exemplary configuration, and that the exemplary embodiment are not limited to the configuration illustrated in FIGS. 17 and 18 insofar as the configuration still enables execution of the modules described in the exemplary embodiment. For example, some modules may also be realized with special-purpose hardware (such as an ASIC, for example), and some modules may be configured to reside within an external system and be connected via a communication link. Furthermore, it may also be configured such that multiple instances of the system illustrated in FIGS. 17 and 18 are connected to each other by a communication link and operate in conjunction with each other. Additionally, besides a personal computer in particular, an exemplary embodiment may also be incorporated into a device such as an information appliance, photocopier, fax machine, scanner, printer, or multi-function device (that is, an image processing device having two or more from among scanning, printing, copying, and faxing functions).

Note that the described program may be provided stored in a recording medium, but the program may also be provided via a communication medium. In this case, a computer-readable recording medium storing a program, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

Potential examples of a recording medium include a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), and a Secure Digital (SD) memory card.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), an internet, an intranet, an extranet, or some combination thereof, or alternatively, by being impressed onto a carrier wave and propagated.

Furthermore, the above program may be part of another program, and may also be recorded to a recording medium together with other separate programs. The above program may also be recorded in a split manner across multiple recording media. The above program may also be recorded in a compressed, encrypted, or any other recoverable form.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image processing device comprising:
a first image receiver that receives a first image used to specify an area within an image read by an image reading device;
a second image receiver that receives a second image read by the image reading device;
a decision unit that decides an area to extract from the second image on the basis of an area specified for the first image; and
an extractor that extracts an image of the area decided by the decision unit from the second image.

2. The image processing device according to claim 1, wherein
the first image receiver receives an image read by an image reading unit provided in a portable information processing device.

3. The image processing device according to claim 1, wherein
the second image receiver receives an image read by the image reading device that reads at a higher resolution than the first image.

4. The image processing device according to claim 2, wherein
the second image receiver receives an image read by the image reading device that reads at a higher resolution than the first image.

5. The image processing device according to claim 1, further comprising:
a storage unit that stores the second image; and
a judgment unit that judges whether or not a second image corresponding to the first image is being stored in the storage unit;
wherein if the judgment unit judges that a second image corresponding to the first image is being stored in the storage unit, the extractor takes a second image corresponding to the first image from the storage unit, and extracts therefrom an image of an area decided by the decision unit.

6. The image processing device according to claim 5, further comprising:
a reporting unit that, in a case in which the judgment unit judges that a second image corresponding to the first image is not being stored in the storage unit, reports to a user that a second image has not been read by the image reading device.

7. An image processing system comprising:
a client device that includes
a camera that captures an original,
a touch panel that displays a first image captured by the camera, and receives a specification of an area on the displayed first image, and
a first transmitter that transmits the first image and information related to an area specified by the touch panel to an image processing device;
a scanner that includes
an image reading unit that reads a second image from the original, and
a second transmitter that transmits the second image to the image processing device; and
an image processing device that includes
a controller that receives the first image, the information related to an area, and the second image, and conducts control to extract image information of an area in the second image that corresponds to the area in the first image.

8. An image processing method comprising:
receiving a first image used to specify an area within an image read by an image reading device;
receiving a second image read by the image reading device;
deciding an area to extract from the second image on the basis of an area specified for the first image; and
extracting an image of the decided area from the second image.

9. A non-transitory computer readable medium storing a program causing a computer to execute a process for processing an image, the process comprising:
receiving a first image used to specify an area within an image read by an image reading device;
receiving a second image read by the image reading device;
deciding an area to extract from the second image on the basis of an area specified for the first image; and
extracting an image of the decided area from the second image.
